(19) United States
(12) Patent Application Publication
(10) Pub. No.: US 2006/0019510 A1
(43) Pub. Date: Jan. 26, 2006

(54) Fastener for assembly and disassembly

(75) Inventors: Dickory Rudduck, Chicago, IL (US); Michael Razic, Randwick (AU); Geoffrey David Sizer, Chicago, IL (US); Michael John Laybourne Hort, Chatswood (AU)

Correspondence Address: WILMER CUTLER PICKERING HALE AND DORR LLP, 399 PARK AVENUE, NEW YORK, NY, 10022, US

(73) Assignee: Telezygology, Inc., Sydney (AU)

(21) Appl. No.: 11/040,930

(22) Filed: Jan. 21, 2005

Related U.S. Application Data
(63) Continuation of application No. PCT/AU03/00933, filed on Jul. 22, 2003.

(30) Foreign Application Priority Data
Jul. 22, 2002 (AU) 2002950303
Dec. 9, 2002 (AU) 2002953229

(51) Int. Cl. H01R 12/00

(52) U.S. Cl. 439/74

(57) ABSTRACT

The invention provides a fastener assembly suitable for joining a first element such as a circuit board to a second element such as a casing or another circuit board. The fastener assembly includes a first component which has a pin and a second component which includes a cavity for receiving at least part of the pin. In one aspect, at least part of the second component capable of being received within a bore in the first element. Either the first component or the second component is made of material which can change from a first shape to a second shape at a particular temperature. The pin of the first component is adapted to be locked into the cavity of the second component when the second shape is attained, through interaction of the material with the cavity, without deformation of the pin.

### RELATED APPLICATIONS

This application is a continuation of International Application No. PCT/AU03/00933, filed Jul. 22, 2003, which was published under PCT Article 21(2) in English and is incorporated herein by reference. International Application No. PCT/AU03/00933 claims priority from Australian Patent Application 2002950303, filed Jul. 22, 2002, which is also incorporated herein by reference, and Australian Patent Application 2002953229, filed on Dec. 9, 2002, which is also incorporated herein by reference.

### TECHNICAL FIELD

This invention relates to improvements in assembly and disassembly. In particular, this invention is concerned with systems of assembly and disassembly which are capable of being more efficient and/or less labour intensive than commonly used methods.

This invention is especially concerned with assembly and disassembly of printed circuit boards. However, the invention is not limited to this.

### BACKGROUND

Printed circuit boards (also called printed wiring boards) are usually assembled using traditional fastening materials, namely mounts and screws. It is desirable to introduce greater efficiency in the assembly of printed circuit boards. It is also desirable to be able to “demanufacture” or disassemble such products, especially to aid recycling of parts and disposal.

It is also desirable to be able to test the effectiveness of fastening and electronic components before or during the assembly procedure. Detection of a faulty fastening or electronic component during assembly rather than at the completion of assembly can enable substitution of a working component and/or can prevent the cost of having to discard an assembly at the end of the process because of the faulty component.

### SUMMARY OF THE INVENTION

Accordingly, the present invention provides a fastener assembly for joining a first element to a second element, the fastener assembly including a first component having a pin and a second component including a cavity for receiving at least part of the pin, at least part of the second component capable of being received within a bore in the first element, wherein either the first component or the second component comprises material adapted to change from a first shape to a second shape at a particular temperature, the pin of the first component being adapted to be locked into the cavity of the second component upon attainment of the second shape, through interaction of the material with the cavity without deformation of the pin.

In another aspect, the present invention provides a fastener assembly for joining a first element to a second element, the fastener assembly including a first component including a pin and a second component including a cavity for receiving at least part of the pin, wherein either the first component or the second component comprises material adapted to change from a first shape to a second shape at a particular temperature generated through heating means included in the first element.

It will also be appreciated that the fastener of the present invention can permit disassembly. This is becoming more and more important. There is increased pressure to recover parts of assemblies, particularly printed circuit board assemblies, especially for recycling purposes. For this purpose, the fastener of the invention in some embodiments has the first and second components being adapted to unlock upon attainment of the first or another shape, as well as being adapted to lock together upon attainment of the second shape.

Consequently, the invention also provides a fastener assembly for joining a first element to a second element, the fastener assembly including a first component having a pin and a second component including a cavity for receiving at least part of the pin, at least part of the second component capable of being received within a bore in the first element, wherein either the first component or the second component comprises material adapted to change from a first shape to a second shape at a particular temperature, the pin of the first component being adapted to be locked into the cavity of the second component upon attainment of the second shape, without deformation of the pin, the pin of the first component being adapted to be unlocked from the second component upon attainment of the first shape or attainment by the first component of a third shape.

Further, the invention provides a first element, preferably a printed circuit board, fastened to a second element using the fastener or the method of the invention.

The invention also provides a first element, preferably a printed circuit board in combination with the first component or the second component of the fastener of the invention.

The invention also provides a method for joining a first element to a second element, the method including the steps of:
(a) providing a first fastening component including a pin and a second fastening component including a cavity for receiving at least part of the pin, at least part of the second component capable of being received within a bore in the first element, either the first fastening component or the second fastening component comprising material adapted to change from a first shape to a second shape at a particular temperature;
(b) inserting the pin in the cavity as far as possible; and
(c) heating the material to or above the particular temperature so that the material interacts with the cavity to lock the pin into the cavity, without deformation of the pin.

The invention also provides method for joining a first element to a second element, the method including the steps of:
(a) providing a first fastening component including a pin and a second fastening component including a cavity for receiving at least part of the pin, either the first fastening component or the second fastening component comprising material adapted to change from a first shape to a second shape at a particular temperature, the first fastening component including material adapted to change to a third shape at a temperature different from the particular temperature;
(b) inserting the pin in the cavity; and
(c) heating the material to or above the particular temperature so that the material interacts with the cavity to lock the pin into the cavity.

In another aspect, the invention provides a fastener assembly for joining a first element to a second element, the fastener assembly including a first component having a pin and a second component including a cavity for receiving at least part of the pin, wherein either the first component or the second component comprises material adapted to change from a first shape to a second shape at a particular temperature, the pin of the first component being adapted to be locked into the cavity of the second component upon attainment of a second shape, the pin of the first component being adapted to be unlocked from the second component upon attainment by the first component of a third shape.

The invention also provides a method of disassembling a first element from a second element, in which the first element is fastened to the second element by the fastener assembly of the invention, the method including the step of heating the material to the particular temperature.

The invention also provides method of disassembling a first element from a second element, in which the first element is fastened to the second element by the fastener assembly of the invention, the method including the step of heating the first component so that it assumes the third shape.

The first element is preferably a printed circuit board. In this embodiment, preferably the energy required for the heating step is provided by means such as resistors included in the circuit board, by means in or on the second element or by means integral with one or both the fastening components.

The second element is preferably a support or part of a casing for the circuit board or may be a second circuit board.

While it is preferred that the first element is a circuit board, it is to be appreciated that the invention in its various aspects is not limited to this. For example, the fastener of the invention can fasten merchandise to a support in a sales outlet. A specific example is a compact disc in a jewel case, fastened to a support until the compact disc is purchased, at which time the vendor can instruct the fastener to release the jewel case and the purchaser can gain access to the compact disc.

As another example, the fastener of the invention can be used to better secure components in computers and the computers themselves, as well as other vibration-sensitive equipment, in land, sea or air vehicles. The fasteners of the invention can provide cushioning as well as fastening in such circumstances. A specific example is the fastening of a casing for a vehicle on-board computer. The fastener of the invention can fasten the computer components within the casing. Further, the fasteners of the invention can fasten the casing into the vehicle, to restrict access and provide security. In such circumstances, the pin may need to have a metal core to deter theft.

As another non-limiting example, service access panels may be secured by the fasteners of the invention.

Many other examples will be apparent to one skilled in the art. The first and second elements are accordingly of wide scope.

The first component has a pin which can take the form of a fastening spigot. The second component, in one embodiment, is a sleeve of shape memory polymer or other suitable material into which at least part of the pin fits. The pin may be slightly oversized and thus able to fit only part way into the sleeve until the material has changed from the first shape to the second shape at the particular temperature. The pin may have an enlarged portion or other shape, such as ribs, which can create an interference fit with the sleeve when the material changes to the second shape.

While the pin may have an enlarged potion or other shape which can create an interference fit with the sleeve when the material attains the second shape, the pin can have other configurations. For example, the pin can have a recessed area. The pin may be of constant cross section, without any protrusions or under cuts. The pin may have any suitable cross section, including round or square.

The pin may be of constant cross section, as may the sleeve. In this case, when the material is heated to the particular temperature, its tendency to change from the first shape to the second shape causes sufficient friction between the pin and the sleeve to lock the pin into the sleeve. As will be apparent to one skilled in the art, there are many variations in shapes which will permit the locking of the pin to the cavity.

The pin may be released by again heating the material of the sleeve. The material of the sleeve may return to its original shape when heated sufficiently, or to a third shape to enable disassembly. Preferably, the heating and reheating process can be repeated.

The pin may be formed integrally with, for example, a case or support for the printed circuit board, or may be separate.

When the second component is a sleeve or plate, it may have one or more holes or cavities (or depressions). An advantage of this is that it can allow fastening of a printed circuit board to both a casing and a second printed circuit board, for example. This facilitates stacking of circuit boards and other parts. The pin may also enable electrical connections between circuit boards, in which case electrically-conductive material such as wire should be incorporated in the pin.

The particular temperature is preferably attained by generating heat by passing current through resistors. The resistors may be fitted as part of the normal circuit board assembly and have two purposes—the primary function of the resistor in the circuit board assembly and a secondary function to generate enough heat to enable attainment of the particular temperature to change the shape of the material during assembly or disassembly.

Alternately to the use of resistors, a heating element or other heating means may be integrated in the assembly, or situated externally, to apply the appropriate amount of heat to the fastener.

Either the first component or the second component may comprise or include the material. Where the second component is a sleeve, it is convenient if it is this component which comprises or includes the material.

The material may be a shape memory material or a material which melts at a suitable temperature, such as a hot melt adhesive. When the first component and/or the second component are appropriately shaped, hot melt adhesive may be suitable for use. Some metals or metal alloys may be suitable. Materials which change phase on the application of a specific amount of heat may also be suitable. A heat releasable epoxy adhesive, which liquefies at 90-130° C., for example, is known and may be suitable. Other materials may also be suitable, such as solder, so that the component of the fastener would self-solder connection of the circuit board to the element. Other materials will be apparent to one skilled in the art or can be ascertained after suitable experimentation.

Shape memory material is known. Any suitable shape memory material may be used. Essentially, a shape memory material can be deformed into a temporary shape and restored to the original shape, usually upon heating in each case. While shape memory material such as nickel/titanium alloys are not excluded, for the purpose of the present invention it is preferred that the shape memory material is a plastic polymer.

Suitable shape memory plastic polymers are available, for example, from The Polymer Technology Group Incorporated of California, USA, under the trademark Calo.MER. The shape memory product is generally a non-reactive thermoplastic, such as polyurethane or polyester thermoplastic elastomers. These adapt to forming in various ways, especially via melt processing, including extrusion and injection moulding. The material may be compounded with fillers and pigments without interfering with shape-memory properties.

The polymer may be a block copolymer with “hard” and “soft” segments which are different chemically and which retain their dominant glass transition temperatures. Such a copolymer can have a lower glass transition temperature and a higher glass transition temperature. The lower glass transition temperature is that of the “soft” segments, while the higher glass transition temperature (also called the crystalline melting point) is that of the “hard” segments.

In the case of such a block copolymer, at temperatures above the lower glass transition temperature but below the upper glass transition temperature, the soft segments are flexible and rubber-like, the hard segments being stiff and rigid. Consequently, the copolymer behaves as a springy thermoplastic elastomer. Because of the molecular weight and chemical structure of the soft segments, the copolymer has considerable mobility at these temperatures. The copolymer exhibits properties of viscous deformation and stress relaxation.

When the temperature is increased above the glass transition temperature of the hard segments, the copolymer becomes a viscous liquid which can be extruded or injection moulded to a chosen shape. This shape is “locked in” by cooling below the upper glass transition temperature.

A temporary shape may be “locked in” by heating the copolymer to a temperature between the lower glass transition temperature and the upper glass transition temperature, so that only the soft segments are viscous and deformable, then cooling the copolymer to a temperature below the lower glass transition temperature. When the copolymer is heated above the lower glass transition temperature, the copolymer will return to the permanent shape previously formed by the high temperature process.

In application to the present invention, the shape memory material may be heated to or above the particular temperature (the lower glass transition temperature in the case of the copolymer), at which stage the shape memory material can be deformed around the other component in the fastener of the invention. On cooling below the lower glass transition temperature, this locks the components together by way of a suitable interference fit force, provided by the hoop stress resulting from the variation in elastic modulus in the shape memory material above and below the lower glass transition temperature. In this configuration the fastener joins the printed circuit board to the element.

To release the element from the circuit board and enable demanufacture or disassembly, the shape memory material may be heated above the lower glass transition temperature once again, causing it to become soft and easily deformed, in which configuration the element can be released from the circuit board.

It will be appreciated that the fastener of the invention can enable disassembly without the need for springs or other positive bias means.

The particular temperature will be determined by the shape memory material used. In the case of Calo.MER shape memory polymer, the particular temperature may be 50 to 60° C. Other shape memory polymers with different glass transition temperatures may be suitable, preferably around 100° C. The material chosen and its particular temperature may vary according to the purpose of the assembly and the expected temperatures to which it will be exposed in use.

If necessary, the material can be insulated as required from other parts which may otherwise be affected by the heat applied to the material.

The material is adapted to change from the first shape to the second shape on the application of suitable heat. In the case of shape memory material, the material may change to the “memorised” shape as far as possible (there may be physical constraints preventing the material from fully attaining the second shape). For other material, the change may be to a shape, which may be determined wholly or partially by the environment of the material.

As discussed, the temperature is preferably obtained by generating heat by passing current through resistors. The resistors may be fitted as part of the normal printed circuit board assembly and may have two purposes. The first purpose is that of the primary function of the resistor in the assembly and the second purpose enables attainment of the desired temperature to change the shape of the material during assembly or disassembly. Thus, there is little extra cost involved, since the resistors would be part of the circuit board assembly even if the fasteners of the invention were not involved. However, where the desired temperature is a relatively high one, it may be necessary to provide additional resistors for the second purpose, to ensure that the desired temperature can be reached.

The fastener of the invention may be attached to the printed circuit board or to the element in any orientation, some examples of which are shown in connection with the drawings, below. The orientation is preferably such as to allow the first component (for example, a pin) to face any convenient direction.

The first and second components may be assembled in relation to the printed circuit board assembly using any suitable assembly technology. For example, a component may be adhered, soldered, riveted, screwed or the like. A component may be fixed in conventional manner or by remote means, e.g., as disclosed in International Patent Application No PCT/AU99/00185, published as WO99/47819. A component may be surface mounted on the printed circuit board on either side, or mounted through the printed circuit board. A component may be integral with the printed circuit board or the element (preferably the latter in the case of the first component).

Connection between the material and an energy source, for providing heating to the requisite temperature, may be by any suitable means.

The fastener of the invention may be connected to an energy and/or data bus.

As stated above, the printed circuit board itself may be made of traditional material (such as fibreglass) or of any other suitable material. Glass has been proposed for this purpose. A drawback of glass printed circuit boards has been that they are inherently brittle and there have been problems in using screws. In the case of a glass printed circuit board, the fastener of the invention may include sufficient resiliency to act as a shock absorber and to assist in preventing damage to the glass in the case of the addition of screws etc. Conveniently, the resiliency may be provided by the material adapted to change from the first to the second shape. It will be appreciated by one skilled in the art that the fastener of the invention can facilitate the manufacture of printed circuit boards on glass.

The fastener of the invention may include internal intelligent means capable of reporting on status, controlling temperature, switching energy and processing interaction with other such fasteners. The fastener of the invention may also incorporate or be associated with a spring or other biasing means to assist separation of the printed circuit board from the element once the components of the fastener have been unlocked.

The fastener of the invention may have different parts, whether in the first component and the second component or otherwise, which can be separately controlled. This can be for the purpose of enabling an assembly instruction through one type of control and a disassembly instruction through a different control. Zero insertion force and zero extraction force can result.

By way of example, the first component may include a first sleeve on the pin and the second component may comprise a second sleeve into which the first sleeve is received. Heating of the second sleeve controls assembly and heating of the first sleeve enables disassembly as shown, for example, in FIGS. 8 to 10 below.

It will be appreciated that the fastener of the invention is capable of providing substantial advantages in the assembly of printed circuit boards. In particular, it is possible using some embodiments of the fastener of the invention to assemble the printed circuit board wholly or partially but without locking the first and second components together immediately, and without stopping the board at a screw insertion station. This means that it is possible to test the efficacy of each electronic and fastener component in situ and, if the component works in situ, to allow the printed circuit board assembly to proceed to the next station in the assembly line. It is anticipated that this will provide great savings in reducing rejection of printed board assemblies because of faulty fastening. It may also eliminate the need for screw insertion stations and may speed up assembly.

It will be appreciated that, using the fastener and method of the invention, it is possible to assemble an element such as a casing, or various parts of casing, to the printed circuit board. This is the reverse of traditional assembly, where the printed circuit board is assembled to the casing. The benefit of assembling the casing to the circuit board is that the circuit board can be set up first in the assembly line and the casing introduced further down the line. Not only can this simplify assembly, it can also permit more easily the use of remote instruction in assembly. After the product has been put into use, it can facilitate servicing.

It may be possible, using the fastener of the invention, to mount removable or replaceable parts of printed circuit board assemblies, such as crystals, ink cartridges, etc. It is feasible that the fastener of the invention may be used as an electrical connector, for example by providing an electrical connection between one circuit board and another (refer FIG. 11 below).

It will further be appreciated that the fastener of the invention, at least in some embodiments, and the method of disassembly of the invention, can facilitate “demanufacture” of printed circuit board products, especially as an aid to recycling.

### BRIEF DESCRIPTION OF THE DRAWINGS

The invention will now be described in connection with certain non-limiting examples thereof as shown in the accompanying drawings, in which:

FIG. 1 is a top plan view of a printed circuit board assembly, showing in each of the corners a first embodiment of the fastener of the invention;

FIG. 2 is a side view of the assembly of FIG. 1;

FIG. 3 is a sectional view of the assembly of FIG. 1;

FIG. 4 is a detailed view of the first embodiment of the fastener of the invention;

FIG. 5 is a cross-sectional view of the first embodiment of the fastener of the invention before insertion of the first component into the second component;

FIG. 6 shows the first embodiment of the fastener with the first and second components locked together;

FIG. 7 is a variation on the embodiment of FIGS. 1-6;

FIG. 8 shows in side sectional view a second embodiment of the fastener of the invention before assembly of a printed circuit board to a casing;

FIG. 9 shows the embodiment of FIG. 8 after assembly;

FIG. 10 shows the embodiment of FIGS. 8 and 9 after disassembly;

FIG. 11 is an expanded, partial perspective view of a case and two printed circuit boards and shows third, fourth, fifth and sixth embodiments of the fastener of the invention;

FIG. 12 illustrates the way in which embodiments of the fastener of the invention can be set up in different orientations;

FIG. 13 is a block diagram showing heating of a fastener of the invention by an external control device; and

FIG. 14 is a block diagram showing heating of a fastener of the invention using resistors on the printed circuit board assembly.

### DETAILED DESCRIPTION

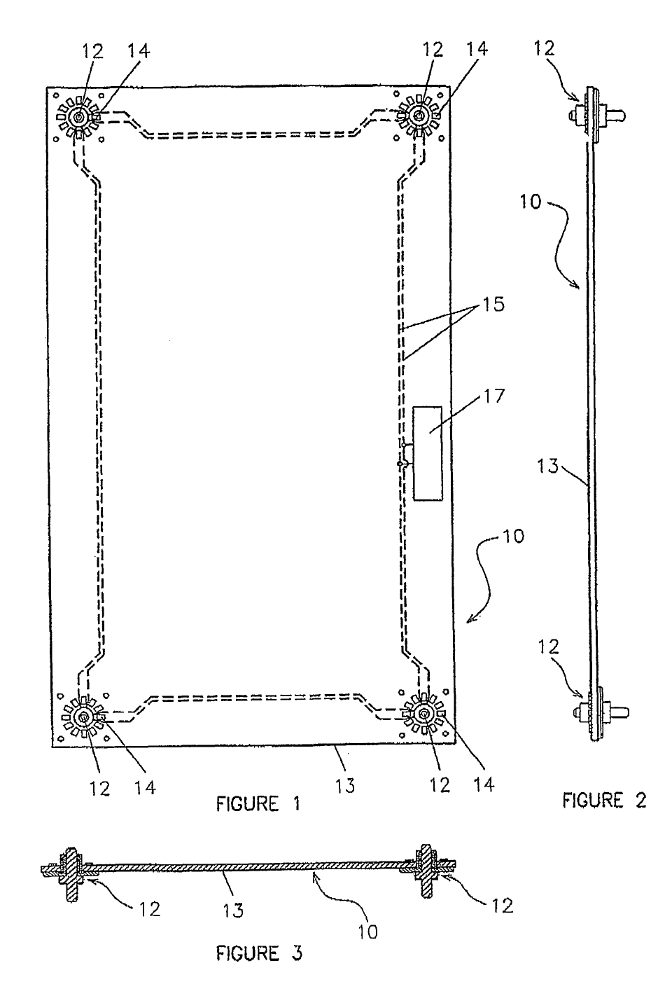

Referring first to FIGS. 1 to 3, printed circuit board assembly 10 includes fasteners 12, one being situated at each of the four corners of printed circuit board 13.

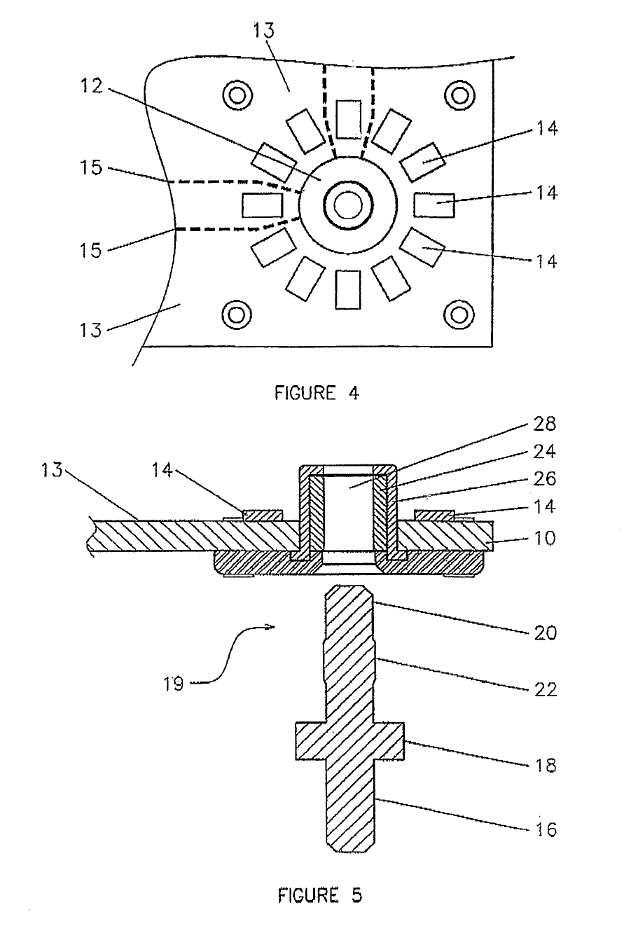

As shown in more detail in FIG. 4, each fastener 12 is surrounded by a number of resistors 14 which can act as a heating element. As illustrated, there are twelve surface mounted resistors, each of size 0805 and each being rated for 0.125 watt dissipation. Instead of twelve there may be, say, eight resistors 14. Other heating arrangements are possible. Heat is generated by passing current through the resistors 14, coupling from the resistors 14 to the fastener 12 being by printed track 15. This is incorporated into the design as part of the electronic and printed circuit board design process. Current to resistors 14 is controlled and delivered by control and energy delivery system 17, included on board 13. The resistors are fitted as part of normal printed wiring board assembly. If desired, a thermal sensor (not shown) may be included to provide feedback of fastener temperature and hence indicate whether the fastener components are locked or released.

Typically, heating power of 2 watts per fastener 12 is practicable. Four fasteners 12 per board 13 will usually be required for small to medium boards as per FIGS. 1 to 3, and more for larger boards.

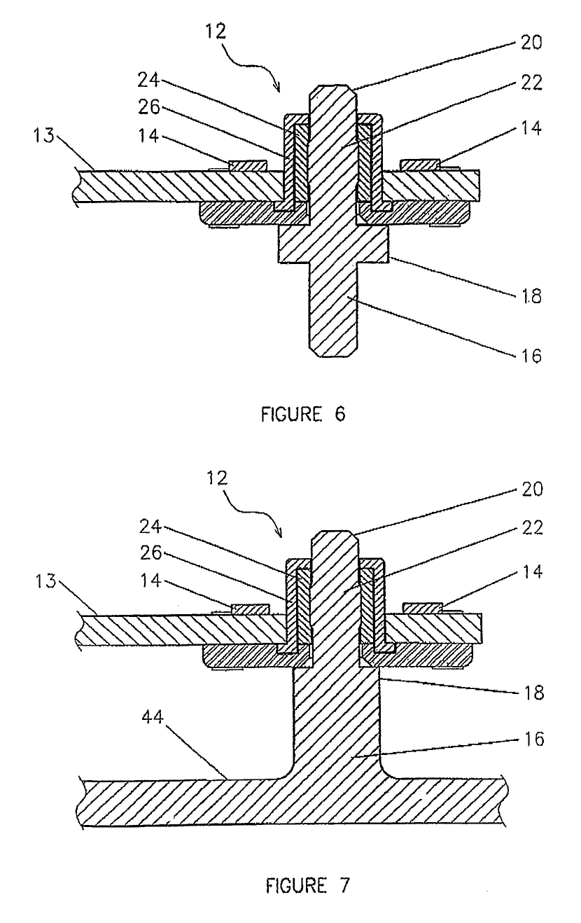

With reference now to FIGS. 5 and 6, first component 19 of fastener 12 has a spigot 16 which includes flange 18 and shank 20.

Shank 20 includes enlarged portion 22, for the purpose of providing the interference fit discussed further below. Shank 20 and enlarged portion 22 are of suitable heat resistant material, such as a plastic acetyl which can be injection moulded.

Fastener 12 also includes second component sleeve 24 which is surrounded by copper sheath 26. Sleeve 24 is of heat-softening plastic material and is shown in its first shape in FIG. 5, namely, with a constant cross-section. In this configuration, shank 20 can enter partly into cavity 28 but is prevented from entering any further by enlarged portion 22, which has too large a diameter to fit cavity 28.

The heat-softening material of sleeve 24 is either shape memory polymer or hot melt adhesive.

To lock sleeve 24 to shank 20, sleeve 24 is heated by current passing along track 15 through resistors 14, heat being conducted to sleeve 24 by copper sheath 26. Once the threshold temperature (for example, 60° C.) has been reached, sleeve 24 softens and deforms to allow shank 20, including enlarged portion 22, to pass into cavity 28.

As shown in FIG. 6, once shank 20 has passed into cavity 28, further passage being prevented by flange 18, current can be discontinued to resistors 14, allowing sleeve 24 to cool and harden around shank 20 and enlarged portion 22. The interference fit between enlarged portion 22 and sleeve 24 in its second shape will prevent withdrawal of sleeve 24 from shank 20. Consequently, printed circuit board assembly 10 is fastened to its mounting (not shown) via fastener 12.

The arrangement in FIG. 7 is the same as in FIG. 6, except that the spigot 16 is integrally moulded with tray 44, which in this embodiment is the element or mounting to which board 13 is fastened.

To disassemble, sleeve 24 is heated, as before, to or above the threshold temperature, at which sleeve 24 softens (and resumes its original shape when sleeve 24 is of shape memory polymer), allowing shank 20 and enlarged portion 22 to be withdrawn from cavity 28 or to fall out of cavity 28 under the influence of gravity.

Turning now to the embodiment in FIG. 8, the fastener in this embodiment has more than two components. These include pin 60 formed integrally with casing 62. Pin 60 has mounted around it collar 64 of shape-changeable material. Printed circuit board 66 has mounted on it component 68 of a second type of shape-changeable material. Printed circuit board 66 also includes resistors 70.

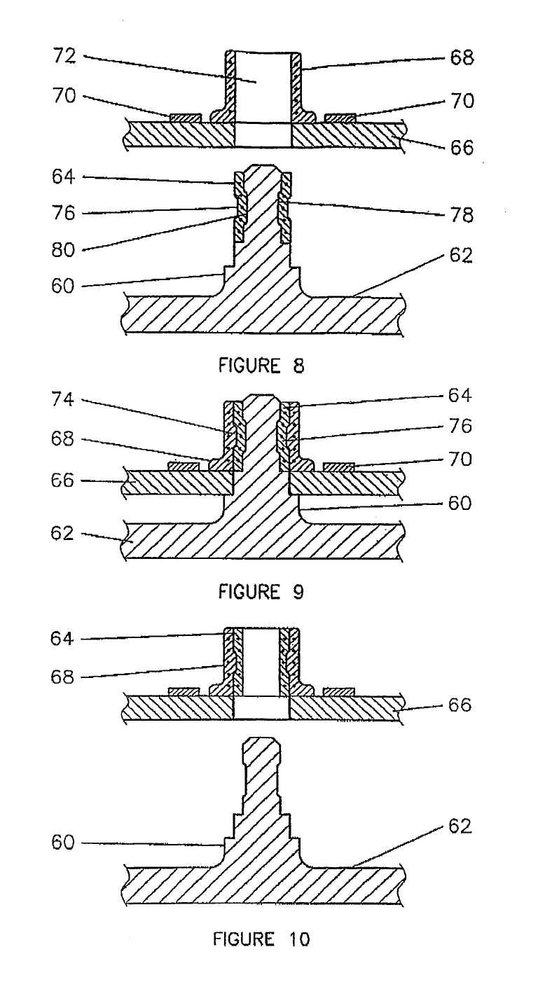

Collar 64 is able to fit into through-hole 72 of component 68. When sufficient heat is supplied via resistors 70, the material in component 68 changes shape to provide protrusion 74 (refer FIG. 9) fitting into recess 76 on collar 64, providing a lock between them.

To disassemble printed circuit board 66 from casing 62, heat is supplied by suitable means (such as by resistors 70) to collar 64 which changes shape as shown in FIG. 10, unlocking protrusions 78 (refer FIG. 8) from channel 80. This permits pin 60 to disengage from printed circuit board 66. A spring (not shown) may bias printed circuit board 66 away from casing 62.

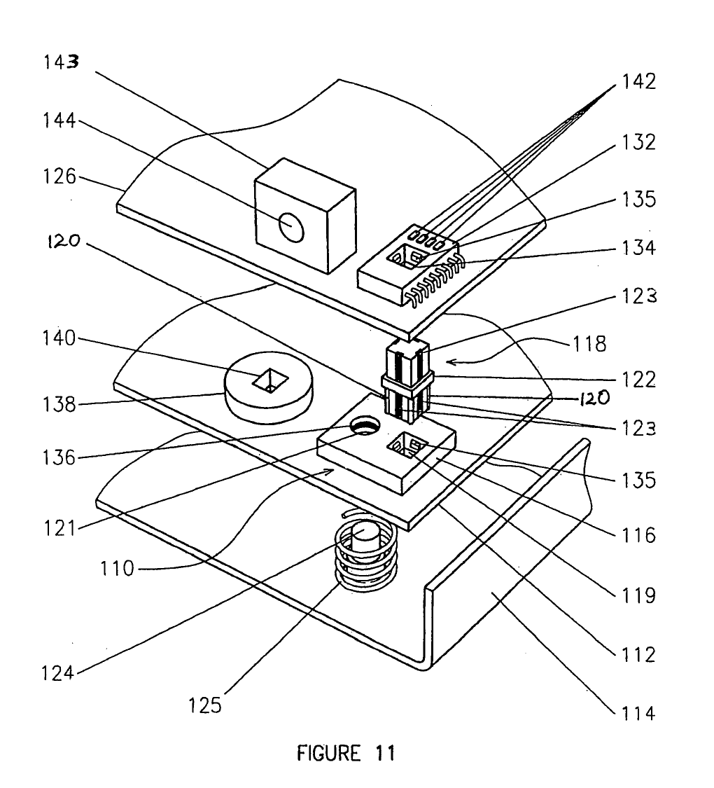

Referring now to FIG. 11, this has four different embodiments of components for the fastener of the invention. In the third embodiment, fastener 110 has a first flat component 116 and a second pin-type component 118. First component 116 contains blind cavity 119 and through hole 121. It is cavity 119 which forms part of the third embodiment. Pin 118 includes (below collar 122) protrusions 120 at each corner of pin 118. Protrusions 120 are made of the shape-changeable material. When sufficient heat is applied to pin 118 (via resistors 142, see below, or other means), the protrusions 120 deform so that pin 118 fits into and forms a friction lock with blind cavity 119.

In this third embodiment, pin 118 is used to join printed circuit board 112 with a second, stacked printed circuit board 126. Printed circuit board 126 includes as first component flat plate 132 which includes heating means, being resistors 142, connected to an electrical current, such as in the first embodiment. Plate 132 includes a through-hole 134. Printed circuit board 126 is assembled so that the upper part of pin 118 rests against the lower part of through-hole 134. When resistors 142 are activated, shape-changeable material beneath electrical contacts 135 in plate 132 are heated sufficiently to change shape and lock pin 118 into hole 134 of plate 132, at the same time pushing contacts 135 towards pin 118 for electrical contact, as explained further below. The result is a two-layered stack of printed circuit boards 112 and 126, spaced by collar 122.

Both holes 119 and 134 contain electrical contacts 135. Pin 118 includes metal strips 123 to electrically connect plates 116 and 132 via contacts 135, and hence boards 112 and 126. Pin 118 hence acts as a plug between boards 112 and 126.

To disassemble, current is applied to resistors 142. When sufficient heat is applied to pin 118, protrusions 120 change shape, and the shape memory material beneath contacts 135 in plate 132 also change shape, so that circuit boards 112 and 126 can be disengaged.

In relation to the fourth embodiment, the two-layered stack of printed circuit boards 112 and 126, or circuit board 112 alone, as desired, are joined to casing 114 by means of integral pin 124. Through-hole 121 on plate 116 includes shape-changeable material, forming a ridge 136. Application of suitable heat causes ridge 136 to spread vertically, allowing entry of pin 124 and causing locking by friction fit, against the bias of spring 125.

To disassemble, heat applied to ridge 136 will soften it and allow disengagement of pin 124. Under the bias of spring 125, board 112 is pushed apart from base 114.

The fifth embodiment has a first component 138 attached integrally to board 112. This is a circular plate, rather than a rectangular plate as in the case of component 116. Plate 138 has a square through-hole 140. The second component designed to lock into through-hole 140 is not shown but may be, for example, a further pin on casing 114 or a descending pin from printed circuit board 126. This embodiment can resemble in other respects the third or fourth embodiment.

The sixth embodiment of fastener has a component represented by plate 143 which includes circular through-hole 144. Whereas plates 116, 132 and 138 contain cavities or holes designed to receive a pin vertically, hole 144 is intended to receive a pin horizontally. This embodiment is otherwise similar to the third and fourth embodiments.

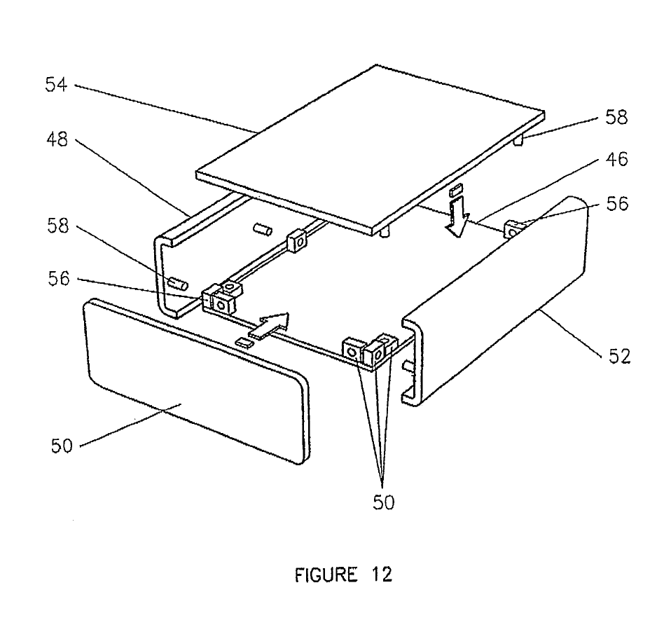

The usefulness of this is illustrated in FIG. 12 which has a printed circuit board 46 which is to be assembled in a casing having sides 48, 50 and 52 and top 54. In this embodiment, printed circuit board 46 has mounted on it a number of components 56 which contain through-holes. The through-holes are designed to accept pins 58 formed integrally with sides 48, 50 and 52 and top 54, according to the method of the invention.

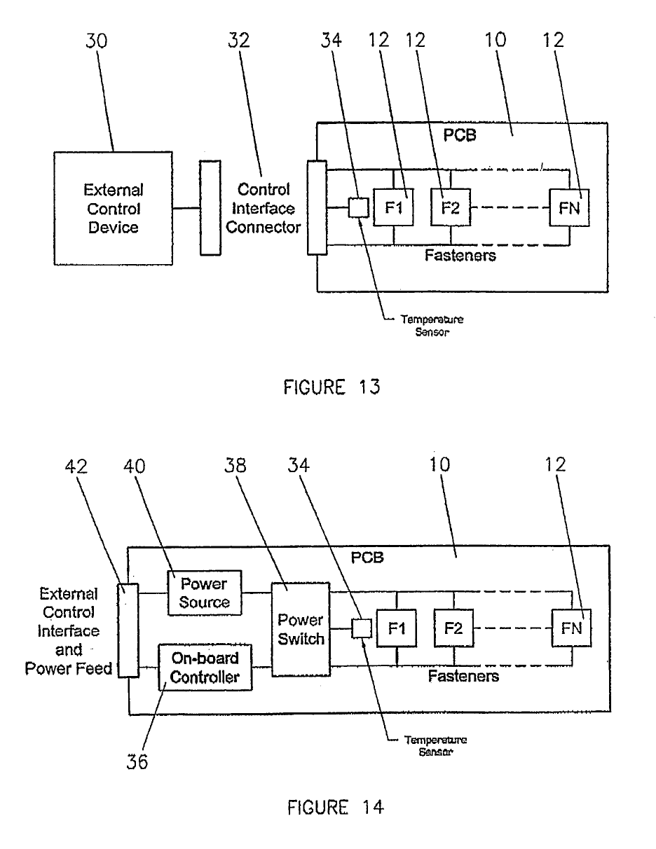

Referring next to FIG. 13, this shows a number of fasteners 12 for which heating is controlled by an external control device 30, utilising a control interface connector 32. This assembly includes a temperature sensor 34. In this embodiment, printed circuit board assembly 10 includes heating resistors (not shown).

In the embodiment shown in FIG. 14, heating of the fasteners is controlled by microcontroller 36, which forms part of the printed circuit board assembly 10 and which has a primary function, relevant to the particular printed circuit board assembly, as well as its function for controlling heating of the fasteners 12. The embodiment includes heating resistors (not shown) as well as power switch 38, such as a transistor, to turn heating current on or off under control of microcontroller 36. Temperature sensor 34 is included. Power source 40 provides power for heating of the resistors.

Control of fasteners 12 via microcontroller 36 can be directed by means, such as a push button or jumper on assembly 10, or from an external control interface 42.

The fasteners, combinations and methods of the invention represent a significant advance in the art. The localised application of heat specifically to a fastener is now possible, with excellent control. This contrasts with prior art attempts at disassembly, where heat tunnels, hot air or infra-red energy have been proposed. The present invention is far more precise, flexible and controllable.

In printed circuit board assembly, fastening may be carried out at any desired time, such as after quality control procedures. Fastening becomes a flexible part of the procedure. An automated assembly programme can instruct fastening after checking that all parts are in place and are operative.

What is claimed is:

1. A fastener assembly for joining a first element to a second element, the fastener assembly comprising a first component including a pin and a second component including a cavity for receiving at least part of the pin, at least part of the second component capable of being received within a bore in the first element, wherein either the first component or the second component comprises material adapted to change from a first shape to a second shape at a particular temperature, the pin of the first component being adapted to be locked into the cavity of the second component upon attainment of the second shape, through interaction of the material with the cavity, without deformation of the pin.

2. A fastener assembly for joining a first element to a second element, the fastener assembly comprising a first component including a pin and a second component including a cavity for receiving at least part of the pin, wherein either the first component or the second component comprises material adapted to change from a first shape to a second shape at a particular temperature generated through heating means included in the first element.

3. A fastener assembly for joining a first element to a second element, the fastener assembly comprising a first component including a pin and a second component including a cavity for receiving at least part of the pin, at least part of the second component capable of being received within a bore in the first element, wherein either the first component or the second component comprises material adapted to change from a first shape to a second shape at a particular temperature, the pin of the first component being adapted to be locked into the cavity of the second component upon attainment of the second shape, without deformation of the pin, the pin of the first component being adapted to be unlocked from the second component upon attainment of the first shape or attainment by the first component of a third shape.

4. The assembly of any one of claims 1 to 3, wherein the pin has a first portion being of larger cross-sectional area than a second portion and the cavity is adapted to receive the second portion but not the first portion until the material has attained the second shape.

5. The assembly of any one of claims 1 to 2, wherein the first component includes a sleeve comprising material adapted to change from a first shape to a second shape at a temperature which is different from the particular temperature.

6. The assembly of claim 3, wherein the first component includes a sleeve comprising material adapted to change from a first shape to a second shape at a temperature which is different from the particular temperature.

7. The assembly of claim 6, wherein the sleeve of the first component enables the pin to be unlocked from the second component upon attainment of the first shape or a third shape by the sleeve of the first component at the different temperature.

8. The assembly of claim 7, in which the third shape is different from the first shape.

9. A fastener assembly for joining a first element to a second element, the fastener assembly comprising a first component including a pin and a second component including a cavity for receiving at least part of the pin, wherein either the first component or the second component comprises material adapted to change from a first shape to a second shape at a particular temperature, the pin of the first component being adapted to be locked into the cavity of the second component upon attainment of a second shape, the pin of the first component being adapted to be unlocked from the second component upon attainment by the first component of a third shape.

10. The assembly of any one of claims 1, 2, 3 or 9, wherein the material is a shape memory polymer.

11. The assembly of any one of claims 1, 2, 3 or 9, wherein the material is a hot melt adhesive.

12. The assembly of any one of claims 1, 2, 3 or 9, wherein the second component is a sleeve comprising the material.

13. The assembly of any one of claims 1, 2, 3 or 9, wherein the first element is a first printed circuit board.

14. The assembly of claim 13, wherein the second element is a second printed circuit board or a casing for a circuit board.

15. The assembly of claim 13, wherein the particular temperature is generated by heating means included in the first circuit board.

16. The assembly of claim 14, wherein the particular temperature is generated by heating means included in the second circuit board.

17. The assembly of claim 15, wherein the heating means is at least one resistor.

18. The assembly of claim 16, wherein the heating means is at least one resistor.

19. The assembly of claim 13, wherein the circuit board is made of glass.

20. The assembly of claim 14, wherein the circuit board is made of glass.

21. A first element fastened to a second element by the fastener assembly of any one of claims 1, 2, 3 or 9.

22. A first element combined with the first component or the second component of the fastener assembly of any one of claims 1, 2, 3 or 9.

23. The first element of claim 21, further combined with a spring biasing the first element away from the second element.

24. The first element of claim 22, further combined with a spring biasing the first element away from the second element.

25. A method for joining a first element to a second element, the method comprising the steps of:
(a) providing a first fastening component including a pin and a second fastening component including a cavity for receiving at least part of the pin, at least part of the second component capable of being received within a bore in the first element, either the first fastening component or the second fastening component comprising material adapted to change from a first shape to a second shape at a particular temperature;
(b) inserting the pin in the cavity as far as possible; and
(c) heating the material to or above the particular temperature so that the material interacts with the cavity to lock the pin into the cavity, without deformation of the pin.

26. The method of claim 25, wherein the pin has a first portion being of larger cross-sectional area than a second portion and wherein step (b) further comprises inserting the second portion of the pin but not the first portion of the pin in the cavity.

27. A method for joining a first element to a second element, the method comprising the steps of:
(a) providing a first fastening component including a pin and a second fastening component including a cavity for receiving at least part of the pin, either the first fastening component or the second fastening component comprising material adapted to change from a first shape to a second shape at a particular temperature, the first fastening component including material adapted to change to a third shape at a temperature different from the particular temperature;
(b) inserting the pin in the cavity; and
(c) heating the material to or above the particular temperature so that the material interacts with the cavity to lock the pin into the cavity.

28. The method of claim 25 or 27, wherein the material is a shape memory polymer.

29. The method of claim 25 or 27, wherein the material is a hot melt adhesive.

30. The method of claim 25 or 27, wherein the second fastening component is a sleeve comprising the material.

31. A method of disassembling a first element from a second element, in which the first element is fastened to the element by the fastener assembly of any one of claims 1, 2, 3 or 9, the method comprising the step of heating the material to the particular temperature.

32. A method of disassembling a first element from a second element, in which the first element is fastened to the second element by the fastener assembly of claim 7, the method comprising the step of heating the sleeve of the first component to the different temperature.

33. A method of disassembling a first element from a second element, in which the first element is fastened to the second element by the fastener assembly of claim 9, the method comprising the step of heating the first component so that it assumes the third shape.

34. The method of any one of claims 25 or 27, wherein the second element forms part of a casing for the first element.

35. The method of claim 31, wherein the second element forms part of a casing for the first element.

36. The method of claim 32, wherein the second element forms part of a casing for the first element.

37. The method of claim 33, wherein the second element forms part of a casing for the first element.

38. The method of claim 31, wherein the second element forms part of a casing for the first element and the fastener assembly includes a spring biasing the first element away from the second element.

39. The method of claim 32, wherein the second element forms part of a casing for the first element and the fastener assembly includes a spring biasing the first element away from the second element.

40. The method of any one of claims 25 or 27, wherein the first and second elements are printed circuit boards.

41. The method of claim 31, wherein the first and second elements are printed circuit boards.

42. The method of claim 32, wherein the first and second elements are printed circuit boards.

43. The method of claim 33, wherein the first and second elements are printed circuit boards.

44. A first element joined to a second element by the method of claim 25 or 27.

45. A first element disassembled from a second element by the method of claim 31.

46. A first element disassembled from a second element by the method of claim 33.
